(19) United States
(12) Patent Application Publication
(10) Pub. No.: US 2026/0352066 A1
(43) Pub. Date: Nov. 5, 2026

(54) AXIAL FLUX ROTARY ELECTRIC MACHINE

(71) Applicant: VALEO ELECTRIFICATION, Creteil Cedex (FR)

(72) Inventors: Khadija EL BARAKA, Creteil Cedex (FR); Svetislav JUGOVIC, Creteil Cedex (FR)

(73) Assignee: VALEO ELECTRIFICATION, Creteil Cedex (FR)

(21) Appl. No.: 19/140,056

(22) PCT Filed: Dec. 8, 2023
(86) PCT No.: PCT/EP2023/084973

§ 371 Date: Jun. 17, 2025

(30) Foreign Application Priority Data
Dec. 22, 2022 (FR) FR2214194

(51) Int. Cl. H02K 9/19; H02K 7/116; H02K 21/24

(52) U.S. Cl. CPC H02K 9/19; H02K 7/116; H02K 21/24

(57) ABSTRACT

An axial-flux rotary electric machine having an axis of rotation, including at least one rotor, and at least one stator arranged face-to-face with said at least one rotor in an axial direction, forming an air gap. The stator includes a plurality of electrical windings which are inscribed between a radially internal contour and a radially external contour, an enclosure in which the stator is placed, and a distribution chamber for distributing a cooling fluid, in particular a dielectric fluid. The distribution chamber communicates with the enclosure via at least one spray opening passing through an annular wall of this enclosure which surrounds the radially external contour of the electrical windings, this spray opening being configured to spray cooling fluid coming from this distribution chamber into the enclosure.

The present invention relates to an axial-flux rotary electric machine, in particular configured to contribute to the propulsion of an electric vehicle.

Patent application US2021288554 discloses an axial-flux motor comprising a circulation system for circulating a cooling fluid in an air gap between a stator and a rotor.

The invention seeks to improve the cooling of an axial-flux rotary electric machine.

One subject of the invention is thus an axial-flux rotary electric machine having an axis of rotation, comprising:
at least one rotor,
at least one stator arranged face-to-face with said at least one rotor in an axial direction, forming an air gap, this stator comprising:
   a plurality of electrical windings which are inscribed between a radially internal contour and a radially external contour,
an enclosure in which the stator is placed,
a distribution chamber for distributing a cooling fluid, in particular a dielectric fluid, this distribution chamber communicating with the enclosure via at least one spray opening passing through an annular wall of this enclosure which surrounds the radially external contour of the electrical windings, this spray opening being configured to spray cooling fluid coming from this distribution chamber into the enclosure.

According to one of the aspects of the invention, the distribution chamber is formed between the annular wall of the stator enclosure and a casing, in particular a gearbox casing.

The present invention thus makes it possible to cool the axial-flux rotary electric machine by spraying a fluid. The distribution chamber for distributing the stream of cooling fluid, for example oil, is disposed between an interior wall of the gearbox and an exterior wall of the stator enclosure. The invention makes it possible to have an assembly that is compact while providing a better heat dissipation effect as a result of the spraying of fluid.

According to one of the aspects of the invention, the distribution chamber has an annular shape.

According to one of the aspects of the invention, the distribution chamber is delimited axially by at least one seal, in particular two seals positioned such that they are offset along the axis of rotation.

According to one of the aspects of the invention, these seals bear against, on the one hand, a wall of the casing and, on the other hand, the annular wall of the enclosure.

For example, the seals are silicone-based.

According to one of the aspects of the invention, the seal or seals are of the O-ring type.

As a variant, the seal or seals are of the flat gasket type.

According to one of the aspects of the invention, the distribution chamber communicates with the enclosure through a plurality of spray openings.

According to one of the aspects of the invention, these spray openings are arranged all around the enclosure, in particular with a regular pitch-spacing between them.

According to one of the aspects of the invention, the spray openings open, at least in the case of some of them, into the enclosure between two circumferentially adjacent windings of the stator.

If so desired, the spray openings open, at least in the case of some of them, into the enclosure on a circumferential face of one of the stator windings.

According to one of the aspects of the invention, the stator enclosure is formed by a housing which comprises a plurality of seats on each of which there bears a tooth carrying one or more of the stator windings.

According to one of the aspects of the invention, the seats are positioned about the axis of rotation, in particular evenly.

According to one of the aspects of the invention, each tooth is interposed, in the axial direction, between a seat of the housing and a seat of the separate support.

According to one of the aspects of the invention, each seat is delimited by two radial branches of the housing.

According to one of the aspects of the invention, each tooth is positioned circumferentially between two adjacent radial branches.

According to one of the aspects of the invention, the branches extend in a straight line, in the radial direction.

According to one of the aspects of the invention, the housing comprises an inner annular wall and an outer annular wall, and the radial branches defining the seats extend radially between this inner annular wall and the outer annular wall.

According to one of the aspects of the invention, the seat for each tooth comprises at least one bearing zone on which the tooth, in particular an end portion of the tooth, bears.

According to one of the aspects of the invention, one of the spray openings for spraying cooling fluid is arranged vertically in line with one of the branches of the housing.

Thus, the cooling fluid is sprayed into the space between two adjacent teeth.

According to one of the aspects of the invention, at least one of the branches comprises a baffle configured to split a stream of cooling fluid from the spray opening into two streams directed toward the two windings which are on either side of the branch.

According to one of the aspects of the invention, this deflector is formed by a projection, in particular in the form of a rib, of the branch.

According to one of the aspects of the invention, the distribution chamber comprises a coolant inlet formed on the casing, and which comprises in particular a connector fitting configured for connecting a coolant supply pipe.

According to one of the aspects of the invention, the enclosure comprises a coolant outlet formed on the housing defining the stator enclosure.

According to one of the aspects of the invention, the coolant outlet comprises a slot on the housing.

Another subject of the invention is an assembly comprising an axial-flux rotary electric machine as mentioned above, and a gearbox provided with a casing, the axial-flux rotary electric machine being housed in a housing portion of the casing.

Further features, details and advantages of the invention will become more clearly apparent upon reading the detailed description given below, and from several exemplary embodiments that are given by way of nonlimiting indication, with reference to the attached schematic drawings, in which:

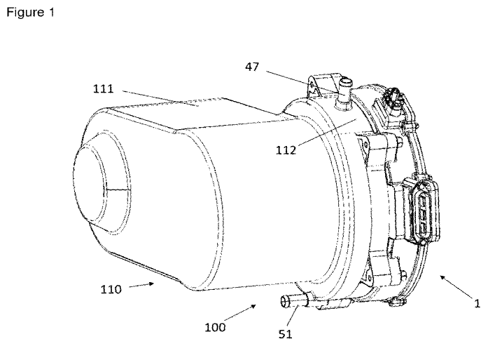

FIG. 1 is a schematic perspective view of an axial-flux rotary electric machine housed in a gearbox casing, according to one exemplary embodiment of the invention;

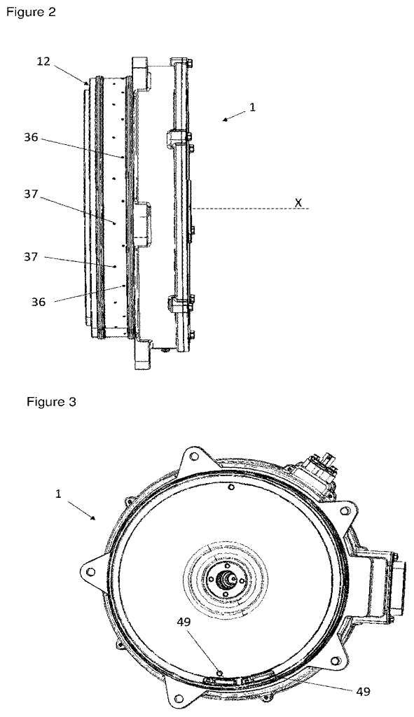

FIG. 2 is a schematic side view of the axial-flux rotary electric machine of FIG. 1;

FIG. 3 is a schematic front view of the axial-flux rotary electric machine of FIG. 1;

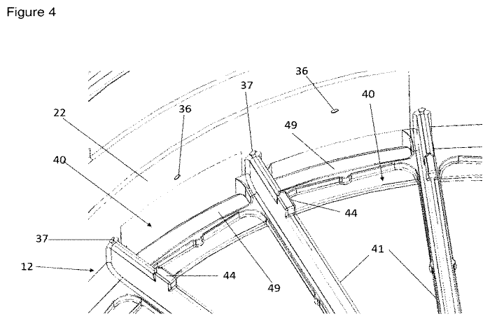

FIG. 4 is a schematic and partial perspective view of a housing of the axial-flux rotary electric machine of FIG. 1;

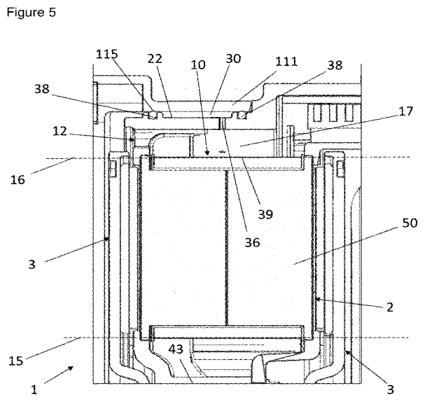

FIG. 5 is a schematic and partial sectional view of the assembly of FIG. 1.

What has been depicted is an axial-flux rotary electric machine 1, of the permanent magnet type, of rotation axis X, comprising a stator 2 and two rotors 3 placed one on each side of the stator 2, axially face-to-face with this stator 2. The stator 2 and rotors 3 are visible in cross section in FIG. 5.

In the example described, the axial-flux electric machine 1 is configured to operate in motor mode and in generator mode. In this instance, it is a permanent-magnet synchronous motor for the propulsion of an electric vehicle.

FIG. 1 shows an assembly 100 comprising the axial-flux rotary electric machine 1 and a gearbox 110 provided with a casing 111, the axial-flux rotary electric machine 1 being housed in a housing portion 112 of the casing 111.

As is known, each rotor 3 comprises a plate carrying a plurality of permanent magnets having an outline substantially in the shape of a disk sector.

The stator 2 comprises a plurality of electrical windings 10, a plurality of teeth 50 carrying these electrical windings 10. A housing 12 is configured to bear the plurality of teeth 50.

The windings 10 on the teeth 50 together form an overall winding of the stator, for example of the three-phase type. These windings 10 are produced by turns of electrical wires around each tooth.

Each tooth 50 comprises a radial stack of grain-oriented electrical steel laminations.

As a variant, each tooth is made of soft magnetic composite (SMC), in particular obtained by sintering.

The windings 10 are configured to be electrically powered so as to generate a magnetic field capable of producing, with the rotors 3 of the axial-flux electric machine 1, an output torque.

A resin, in particular an epoxy resin, can be deposited on the turns of the windings 10.

The electrical windings 10 are inscribed between a radially internal contour 15 and a radially external contour 16.

The housing 12 forms an enclosure 17 for receiving the stator 2 and the rotors 3.

As can be seen in FIG. 5, a distribution chamber 30 for distributing a dielectric cooling fluid is formed between an annular wall 22 of the housing 12 and the casing 111.

This distribution chamber 30 communicates with the enclosure 17 via spray openings 36 and 37 passing through the annular wall 22 of the enclosure 17 which surrounds the radially external contour 16 of the electrical windings 10.

These spray openings 36 and 37 are configured to spray cooling fluid coming from this distribution chamber 30 into the enclosure 17.

The distribution chamber 30 has an annular shape, around the housing 12.

The distribution chamber 30 is delimited axially along the axis X by two annular seals 38 positioned such that they are offset along the axis of rotation X.

These seals 38 bear against, on the one hand, an internal wall 115 of the casing 111 and, on the other hand, the annular wall 22 of the housing 12.

For example, the seals 38 are silicone-based.

The spray openings 36 and 37 are arranged all around the enclosure 17, with a regular pitch-spacing between them.

The housing 12 comprises a plurality of seats 40 on each of which there bears a tooth 50 carrying the stator windings 10.

These seats 40 are arranged, evenly, about the axis of rotation X.

Each tooth 50 is interposed, in the axial direction X, between a seat 40 of the housing 12 and a similar seat of a support (not shown) on the other side of the teeth.

Each seat 40 is delimited by two radial branches 41 of the housing 12. Each tooth 50 is positioned circumferentially between two adjacent radial branches 41.

The branches 41 extend in a straight line, in the radial direction.

The housing 12 comprises an inner annular wall 43 and an outer annular wall 22, and the radial branches 41 defining the seats extend radially between this inner annular wall 43 and the outer annular wall 22.

The seat 40 for each tooth 50 comprises at least one bearing zone on which an end portion of the tooth 50 bears.

A distinction is made between two groups of spray openings 36 and 37, these being respectively arranged in two rows which are offset axially along the axis X, as can be seen clearly in FIG. 2.

In the case of the spray openings 36, these open out into the enclosure 17 on a circumferential face 39 of each of the stator windings 10.

As for the spray openings 37, these open out into the enclosure 17, between two circumferentially adjacent stator windings 10.

Each opening of the cooling-fluid spray openings 37 is disposed vertically in line with one of the branches 41 of the housing 12.

Thus, the cooling fluid is sprayed into the space between two adjacent teeth 50.

The branches 41 comprise a baffle 44 configured to split a stream of cooling fluid from the spray opening 37 into two streams directed toward the two windings 10 which are on either side of the branch 41.

This baffle 44 is formed by a projection, in the form of a rib, of the branch 41.

The distribution chamber 30 comprises a coolant inlet 47 formed on the casing 111 in the form of a connector fitting configured for connecting a coolant supply pipe.

The enclosure 17 comprises a coolant outlet 48 formed on the housing 12 in the form of two kidney-bean slots 49. These slots 49 are adjacent to the outer periphery of this housing 12, at a low point to facilitate the evacuation of cooling fluid, as illustrated in FIG. 3.

The fluid which is evacuated from the enclosure 17 via these slots 49 is then evacuated via a tube 51 on the casing 111.

The slots may be of different shapes and/or in different numbers. The slot can be a single slot rather than two slots.

The openings 36 and 37 may be circular or, alternatively, oblong. The number of them may vary, and they may also be arranged in different numbers of rows.

1. An axial-flux rotary electric machine having an axis of rotation, comprising:
at least one rotor;
at least one stator arranged face-to-face with said at least one rotor in an axial direction, forming an air gap, this stator comprising:
a plurality of electrical windings which are inscribed between a radially internal contour and a radially external contour,
an enclosure in which the stator is placed,
a distribution chamber for distributing a cooling fluid, in particular a dielectric fluid, this distribution chamber communicating with the enclosure via at least one spray opening passing through an annular wall of this enclosure which surrounds the radially external contour of the electrical windings, this spray opening being configured to spray cooling fluid coming from this distribution chamber into the enclosure.

2. The machine as claimed in claim 1, wherein the distribution chamber is formed between the annular wall of the stator enclosure and a casing of a gearbox.

3. The machine as claimed in claim 1, wherein the distribution chamber is delimited axially by at least one seal, in particular two seals positioned such that they are offset along the axis of rotation.

4. The machine as claimed in claim 1, wherein the distribution chamber communicates with the enclosure through a plurality of spray openings.

5. The machine as claimed in claim 4, wherein these spray openings are arranged all around the enclosure in particular with a regular pitch-spacing between them.

6. The machine as claimed in claim 1, wherein the spray openings open, at least in the case of some of them, into the enclosure between two circumferentially adjacent windings of the stator.

7. The machine as claimed in claim 1, wherein the stator enclosure is formed by a housing which comprises a plurality of seats on each of which there bears a tooth carrying one or more of the stator windings.

8. The machine as claimed in claim 7, wherein each seat is delimited by two radial branches of the housing.

9. The machine as claimed in claim 8, wherein one of the spray openings for spraying cooling fluid is arranged vertically in line with one of the branches of the housing.

10. The machine as claimed in claim 9, wherein at least one of the branches comprises a baffle configured to split a stream of cooling fluid from the spray opening into two streams directed toward the two windings which are on either side of the branch.

11. An assembly comprising an axial-flux rotary electric machine as claimed in claim 1, and a gearbox provided with a casing, the axial-flux rotary electric machine being housed in a housing portion of the casing.

12. The machine as claimed in claim 2, wherein the distribution chamber is delimited axially by at least one seal, in particular two seals positioned such that they are offset along the axis of rotation.

13. The machine as claimed in claim 2, wherein the distribution chamber communicates with the enclosure through a plurality of spray openings.

14. The machine as claimed in claim 2, wherein the stator enclosure is formed by a housing which comprises a plurality of seats on each of which there bears a tooth carrying one or more of the stator windings.

15. An assembly comprising an axial-flux rotary electric machine as claimed in claim 2, and a gearbox provided with a casing, the axial-flux rotary electric machine being housed in a housing portion of the casing.

16. The machine as claimed in claim 3, wherein the distribution chamber communicates with the enclosure through a plurality of spray openings.

17. The machine as claimed in claim 3, wherein the stator enclosure is formed by a housing which comprises a plurality of seats on each of which there bears a tooth carrying one or more of the stator windings.

18. An assembly comprising an axial-flux rotary electric machine as claimed in claim 3, and a gearbox provided with a casing, the axial-flux rotary electric machine being housed in a housing portion of the casing.

19. The machine as claimed in claim 4, wherein the stator enclosure is formed by a housing which comprises a plurality of seats on each of which there bears a tooth carrying one or more of the stator windings.

20. An assembly comprising an axial-flux rotary electric machine as claimed in claim 4, and a gearbox provided with a casing, the axial-flux rotary electric machine being housed in a housing portion of the casing.
